(19) United States
(12) Patent Application Publication
(10) Pub. No.: US 2015/0220953 A1
(43) Pub. Date: Aug. 6, 2015

(54) SYSTEMS, APPARATUSES AND METHODS FOR PERFORMING ENTERPRISE ANALYSIS AND SITE ANALYSIS OF INFORMATION TECHNOLOGY COSTS

(71) Applicants: Kenji Hagiwara, Edgewater, NJ (US); Bard Dema, Ramsey, NJ (US)

(72) Inventors: Kenji Hagiwara, Edgewater, NJ (US); Bard Dema, Ramsey, NJ (US)

(73) Assignee: RICOH COMPANY, LTD., Tokyo (JP)

(21) Appl. No.: 14/172,600

(22) Filed: Feb. 4, 2014

(51) Int. Cl. G06Q 30/02; H04L 29/08; G06F 3/0484

(52) U.S. Cl. CPC G06Q 30/0206; G06F 3/04842; H04L 67/22; G06Q 30/0205

(57) ABSTRACT

Tools (such as systems, apparatuses, methodologies, computer programs, etc.) are provided for performing analysis of information technology provisions and/or costs, for an enterprise or another organization. For example, such tools are configured to quickly obtain data that is needed for the analysis and to present average price as one of the user-selectable options for product cost.

### TECHNICAL FIELD

This disclosure relates to tools (for example, systems, apparatuses, methodologies, computer programs, etc.) for performing an enterprise analysis and/or a site analysis of information technology costs, expenditures, pricing, etc., for an enterprise or another organization.

### BACKGROUND

In the current information age, information technology (IT) tools are extensively used in enterprises and other organizations in order to facilitate communication and processing of information, documents, data, etc. Indeed, it is now rare to find a workflow in an enterprise that does not employ IT tools. The number of IT assets [such as software, computers, printers, scanners, multi-function devices (MFDs), other network-connected or standalone devices] is generally increasing and, as a result, managing and tracking IT expenditures is becoming a daunting task.

While the market for IT assets is expanding, the number of options when one looks for IT tools is also typically increasing. Accordingly, suppliers of IT tools generally find that they need to offer competitive pricing and relevant information, on demand. Thus, even suppliers are commonly looking for improved tools that enable them to be competitive in the relevant market.

While the market for IT assets is expanding, the number of options when one looks for IT tools is also typically increasing. Accordingly, suppliers of IT tools generally find that they need to offer competitive pricing and relevant information, on demand. Thus, even suppliers are commonly looking for improved tools that enable them to be competitive in the relevant market.

One approach for a vendor to make an educated and intriguing sales pitch to a customer or prospective customer is to present a proposal along with an analysis of the current IT expenditures of the customer or prospective customer. Such vendor typically attempts to determine the current IT assets of the customer or prospective customer and then collate cost information regarding such assets. For example, costs can vary based on any of various aspects such as, but not limited to, acquisition type (i.e. lease/purchase), acquisition cost, depreciation of product, service cost, and in the case of printing products/services, consumables (e.g., paper, ink, toner, etc.) cost. Further, the vendor may analyze the needs of the customer or prospective customer in order to be able to offer a package of products and/or services that is attractive to the customer or prospective customer.

There are still many instances in which it is difficult to assess the merits of a proposal, at least from the perspective of price or cost.

There exists a need for improved tools for determining, tracking and/or otherwise managing costs, expenditures, pricing, etc., in connection with information technology devices and other IT assets.

### SUMMARY

Various tools (e.g., systems, apparatuses, methodologies, computer program products, application software, etc.) for performing an enterprise analysis and/or a site analysis of information technology costs can be provided, to include various aspects, features and advantages of the subject matter described herein.

For example, a sales and marketing support application may be configured to perform an enterprise analysis and/or a site analysis of information technology costs, for an enterprises (or another organization). In many instances, such enterprise or organization would have multiple sites. In such instance, the application is configured to register, for each specific site, devices employed at the specific site. Further, the application sets for each device type enterprise parameters (including device type parameters) at an enterprise level for the enterprise and sets for each particular site, site parameters inheriting the corresponding enterprise parameters. In addition, for the devices at the site level, the application automatically populates device parameters data to inherit the device type parameters that were set at enterprise level for the enterprise. Further, the application provides a user interface for the user to set and modify the device parameters data of a particular device at the site level, and to set and modify the device type parameters of each device type at the enterprise level.

Such user interface provides user-selectable options for product cost as a device parameter of a particular device, and the user-selectable options for product cost can include average price of sold units of a device model corresponding to the particular device. For example, the user-selectable options provided for product cost may include average price, suggested retail price (SRP), street price and percent off SRP.

For example, average price (such as provided as the product cost of a particular device for sale) can reflect an average of selling price of units sold in a specified country (or other geographical or political region) of the device model corresponding to the particular device. For each device and for each country (or region), the average price of the device in the country (or region) can be registered. Further, the average price may be site-specific, i.e. for each specific site, the average price is an average of selling price of units of the device model corresponding to the particular device that are or were obtained for, or deployed at, the site. In addition, the suggested retail price (SRP) and street price may be registered along with average price of the device in the country (or region), for each device and for each country (or region).

In another aspect, when a particular device is added as an instance of the corresponding device model, the user-selectable options of the particular device are automatically populated based on the device type parameters of the device model corresponding to the particular device.

In another aspect, when an additional device is registered, the device parameter module calculates and registers, for each specified country (or region) amongst plural countries (or regions), an average price of the additional device in the specified country (or region). Further, in a case that average price is selected as product cost at site level or enterprise level, when the additional device is to be registered, average price is applied as the device price of the additional device.

In another aspect, average price may be updated in real time. For example, when a device price of the particular device is input or modified, the device parameter module calculates and registers, for each specified country (or region) amongst plural countries (or regions), an average price of the particular device in the specified country (or region).

In another aspect of this disclosure, the sales and marketing support application may additionally include an analysis module that is configured to retrieve device parameters data for each device of a site, perform a site analysis based on the retrieved device price data of the devices of the site, and output a site analysis report reflecting the site analysis. Further, for an enterprise analysis, the analysis module may be configured to perform, for each particular site amongst the sites of the enterprise, a site analysis of the particular site, and output an enterprise analysis report that includes the site analysis for each particular site amongst the sites of the enterprise. When average price is selected as product cost at the site level, the site analysis performed by the analysis module applies the average price as product cost of an additional device proposed to be added. Further, in the case that average price is selected as product cost at the enterprise level, the enterprise analysis performed by the analysis module applies the average price as product cost of an additional device proposed to be added.

In another aspect, a method for performing an analysis of devices in an enterprise may include one or more of the following aspects:
(a) registering for each specific site amongst one or more sites of an enterprise, a plurality of devices employed at the specific site;
(b) setting, for each device type, enterprise parameters, including device type parameters, at enterprise level for the enterprise, and setting, for each particular site amongst the one or more sites of the enterprise, site parameters inheriting the corresponding enterprise parameters;
(c) populating, for the plurality of devices at site level amongst the one or more sites of the enterprise, device parameters data to inherit the device type parameters that were set at enterprise level for the enterprise;
(d) providing a device parameter user interface for user to set and modify the device parameters data of a particular device at the site level, and to set and modify the device type parameters of each device type at the enterprise level;
(e) providing through the device parameter user interface a plurality of user-selectable options for product cost as a device parameter of a particular device, wherein the user-selectable options for product cost include average price of sold units of a device model corresponding to the particular device;
(f) registering, for each device and for each country or region amongst plural countries or regions, the average price of the device in the country or region;
(g) registering, for each device and for each country or region amongst plural countries or regions, the average price, suggested retail price (SRP) and street price of the device in the country or region;
(h) registering an additional device for the enterprise, and calculating and registering, for each specified country or region amongst plural countries or regions, an average price of the additional device in the specified country or region;
(i) calculating and registering, when a device price of the particular device is input or modified, for each specified country or region amongst plural countries or regions, an average price of the particular device in the specified country or region;
(j) retrieving the device parameters data for each device amongst plural devices of a site, performing a site analysis based on the retrieved device parameters data of the plural devices of the site, outputting a site analysis report reflecting the site analysis, wherein when average price is selected as product cost at the site level, the site analysis applies the average price as product cost of an additional device proposed to be added.

Many other features, as discussed infra, can be provided to facilitate determining, tracking and/or otherwise managing costs, expenditures, pricing, etc., in connection with IT devices and other assets.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a sales and marketing support application provided to or on a terminal, in accordance with an exemplary embodiment;

FIG. 1B shows a block diagram illustrating a system for performing an enterprise analysis and/or a site analysis, for an enterprise or another organization, in accordance with an exemplary embodiment;

FIG. 1C shows a block diagram illustrating a system for performing an enterprise analysis and/or a site analysis, for an enterprise or another organization, in accordance with another exemplary embodiment;

FIG. 1D shows a block diagram illustrating a system for performing an enterprise analysis and/or a site analysis, for an enterprise or another organization, in accordance with another exemplary embodiment;

FIG. 2A shows a block diagram of an exemplary configuration of a terminal apparatus;

FIG. 2B shows a block diagram of an exemplary configuration of a computing device;

FIG. 3 shows a flow chart illustrating a method performed by sales and marketing support application 101 in FIG. 1A or by a terminal (such as 103 in FIGS. 1B-1D) configured by software or other programming, in accordance with an exemplary embodiment;

FIG. 4 shows an example of user data table and enterprise data table;

FIG. 5 shows an example of a user interface screen provided by the sales and marketing support application shown in FIG. 1A and/or on a terminal in the system shown in FIG. 1B, FIG. 1C or FIG. 1D;

FIG. 6 shows an example of a user interface display screen configured to be displayed by a terminal, in accordance with another exemplary embodiment;

FIG. 7 shows an example of device parameter data;

FIG. 8 shows an example of device price or cost data;

FIG. 9 shows an example of a user interface display screen configured to be displayed by a terminal, in accordance with another exemplary embodiment;

FIG. 10 shows an example of a user interface display screen configured to be displayed by a terminal, in accordance with another exemplary embodiment;

FIG. 11A and FIG. 11B show examples of user interface display screens configured to be displayed by a terminal, in accordance with another exemplary embodiment;

FIG. 12 shows an example of a user interface display screen configured to be displayed by a terminal, in accordance with another exemplary embodiment;

FIG. 13 shows an example of a user interface display screen configured to be displayed by a terminal, in accordance with another exemplary embodiment;

FIG. 14 shows an example of a user interface display screen configured to be displayed by a terminal, in accordance with another exemplary embodiment;

FIG. 15A and FIG. 15B show examples of user interface display screens configured to be displayed by a terminal, in accordance with another exemplary embodiment;

FIG. 16 shows an example of default device parameter data; and

FIG. 17 shows an example of inheritance of device parameters from enterprise to sites and passed on to devices.

### DETAILED DESCRIPTION

This patent specification describes tools (in the form of methods, apparatuses, systems, computer program products, application software, etc.) for performing an enterprise analysis and/or a site analysis of information technology (IT) costs, for an enterprise or another organization. Such tools may be useful to an information technology (IT) administrator or manager, and/or another person who has responsibility for purchasing IT tools and/or tracking or managing IT costs, for an enterprise. On the other hand, such tools may also be configured to be useful to sales and marketing personnel for a supplier of IT equipment, devices, tools, etc., to determine appropriate pricing for a target customer. Thus, although the tools may be referred to herein as a sales and marketing support application, such terminology is applicable regardless of whether the user of the application is a sales and marketing professional. When negotiating prices of products (such as IT tools), multiple costs may be considered. For example, the Suggested Retail Price (SRP) is often considered at the start of the process. SRP is the price at which the manufacturer recommends for the retailer to sell the product (and at which the typical retailer would like to sell the product). Although some customers would be willing to pay the SRP for a purchase, a savvy customer would negotiate with the objective of obtaining the lowest possible Street Price (i.e. the actual price that the product has been sold).

For example, a customer may ask for a “volume discount” (which is often a percentage off the SRP) based on number of units of the product. In such instance, or when discussing price per unit in other instances, the salesperson commonly considers various factors, to determine an acceptable percentage off the SRP to offer to the customer. Such factors may include, but are not limited to, the amount of units, SRP, Street Price, the region/country in which the product is being purchased by the customer, etc.

SRP and Street Price data for each device model may be registered in a system. For example, such registered data may be obtained from a third party database. Thus, the salesperson can often have access to the SRP and Street Price for the product offered for sale, and in addition, SRP and Street Price for similar products of competitors.

On the other hand, the tools described herein can be configured to make available additionally data of average price, as an option for the user. That is, although SRP and Street Price data can establish an upper bound and a lower bound of the range of prices, a salesperson may desire to know an average price, in the middle ground between SRP and Street Price. However, the average price is not necessarily the arithmetic center of such range (that is, halfway between the upper bound and lower bound). The term “average price” can entail the median, that is, between half of the sold units of the device model were sold at or below such median price and half of the sold units were sold at or above such median price. Another approach for determining an average price is to take a mathematical average of the price at which the units were sold (that is, sum such amounts and divide by the number of sold units). In another, modified approach, such average price can be limited to those units that match the parameters specified by the user and/or matching the needs of the enterprise.

In describing exemplary embodiments illustrated in the drawings, specific terminology is employed for the sake of clarity. However, the subject matter of this patent specification is not intended to be limited to the specific terminology so selected and it is to be understood that each specific element includes all technical equivalents that operate in a similar manner.

The drawings show examples of implementations of the subject matter of this patent disclosure in several computing environments. However, it should be understood that the subject matter of this disclosure can be utilized by any computing device including but not limited to PDAs, cell phones, personal, notebook and workstation computers, kiosks, other information terminals, etc. In addition, the subject matter of this disclosure might be provided as services in a modular fashion by other devices connected by a communication network.

Referring now to the drawings, wherein like reference numerals designate identical or corresponding parts throughout the several views, there is described tools (systems, apparatuses, methodologies, computer program products, etc.) for gathering and analyzing enterprise data based on the parameters set by the user.

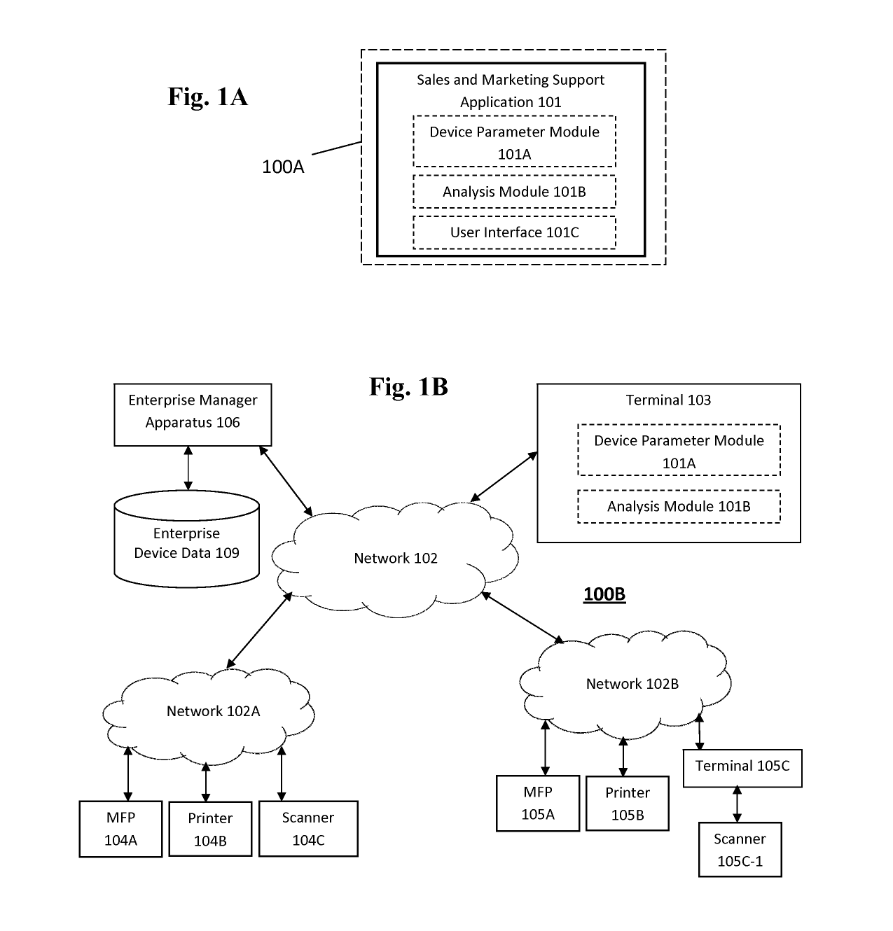

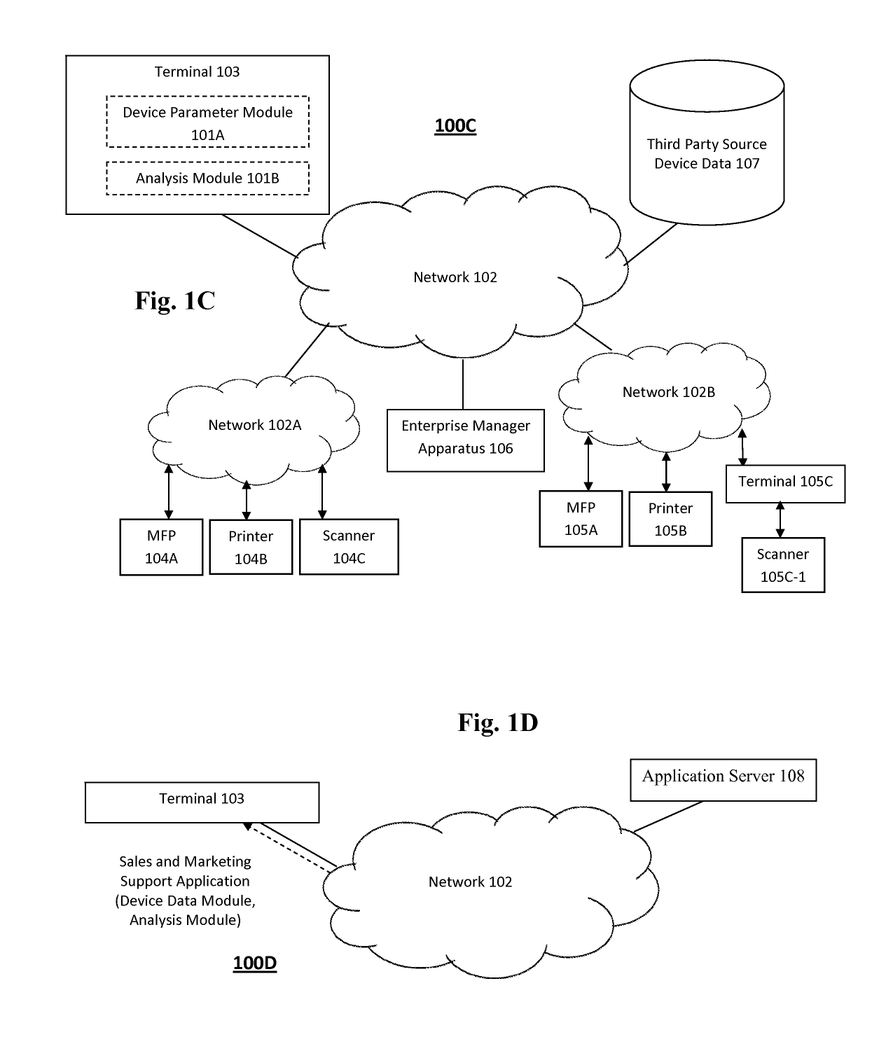

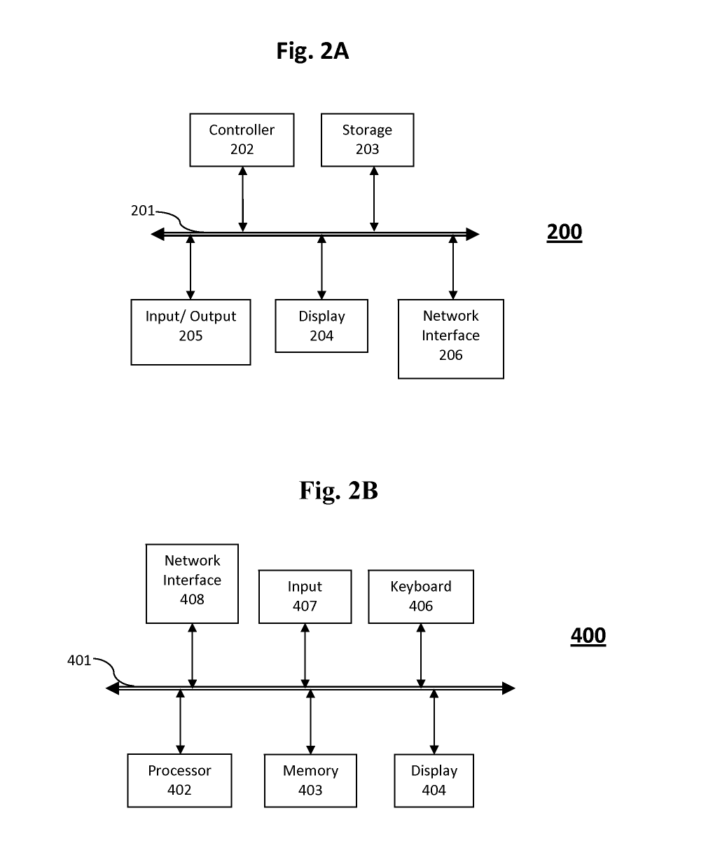

FIG. 1A shows a terminal apparatus 100A configured with an sales and marketing support application 101 to include a device parameter module 101A, an analysis module 101B and a user interface 101C. The terminal apparatus 100A can be implemented on any device including a processor, storage and display, such as, but not limited to, a smartphone, a handset, a tablet, other information terminals, etc., for example, having a configuration such as shown in FIG. 2A.

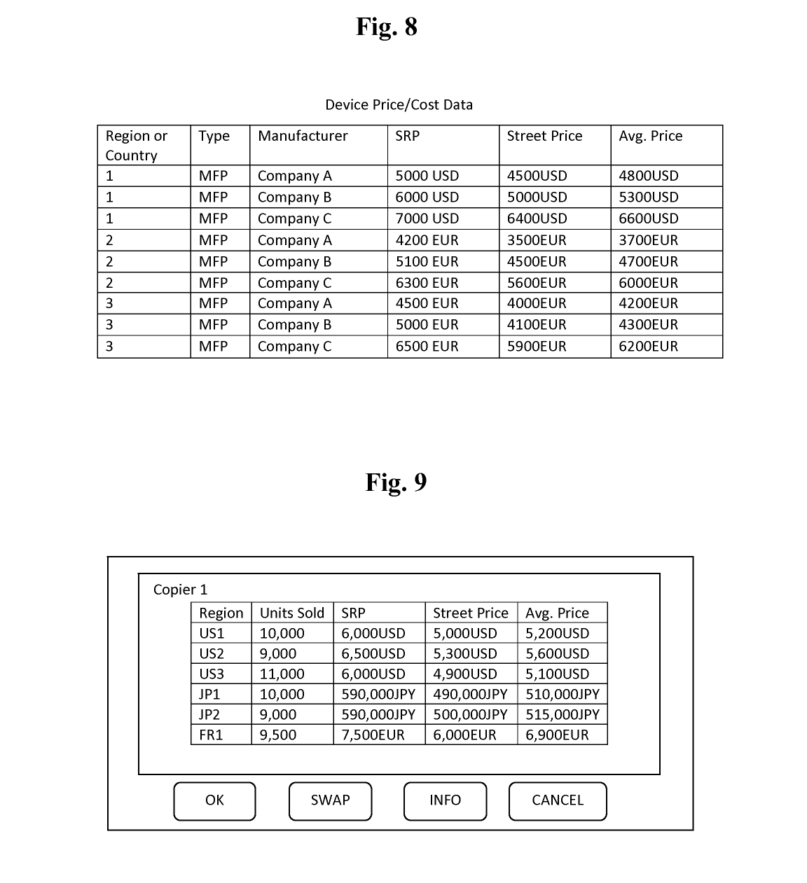

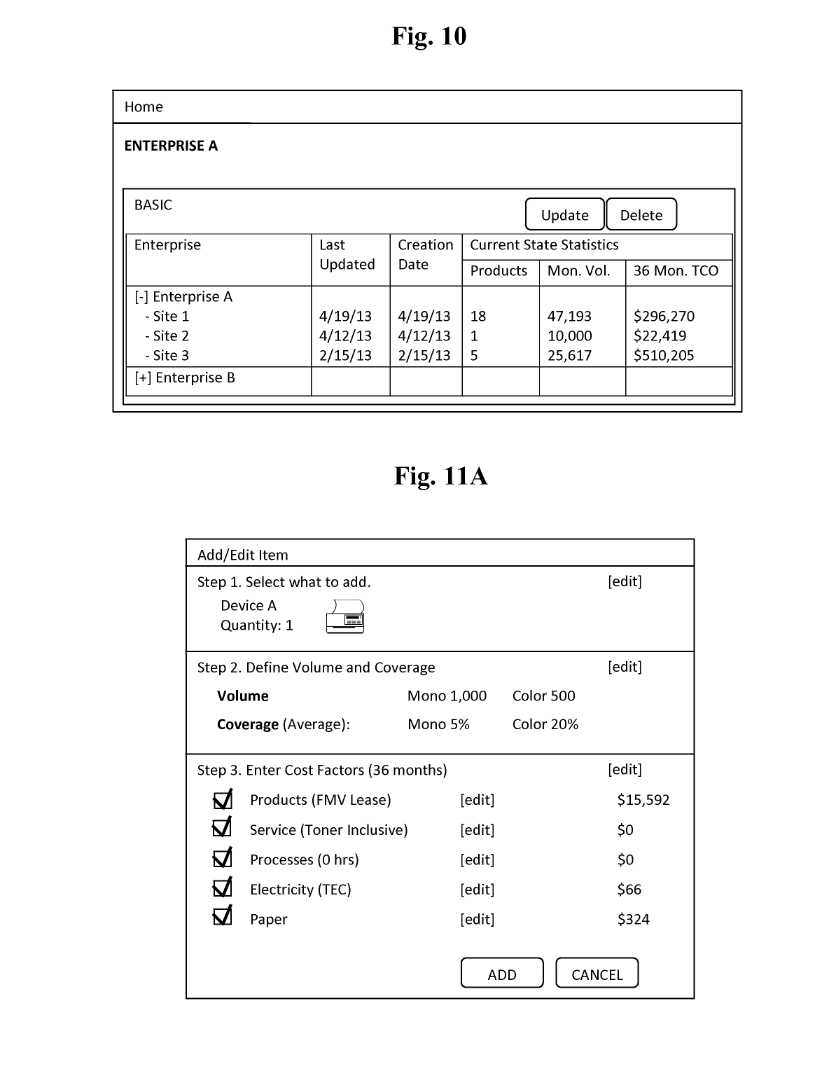

The device parameter module 101A is configured to register and store device data regarding devices employed at specific enterprise or sites on which analyses are being performed, such as but not limited to, printers, scanners, fax machines etc. The device data includes device information, such as, for example, standard retail price (SRP), color capabilities, speed, duplex printing etc., such as shown in FIG. 7, FIG. 8 and FIG. 9. The information depicted in FIG. 7, FIG. 8 and FIG. 9 is merely exemplary, and a wide range of other information may be included in the device information. The information included in FIG. 7, FIG. 8 and FIG. 9 are based on the enterprise parameters set for each device type by the user. The enterprise parameters are then mirrored when performing device analyses on the sites of an enterprise. Although the device information may be stored natively on the host device (in the exemplary embodiment shown in FIG. 1A), similar (more up-to-date) information may be maintained by third party servers as a data bank for information technology equipment, and the terminal apparatus 100A may be configured to access such third party servers (such as in the configuration shown in FIG. 1C).

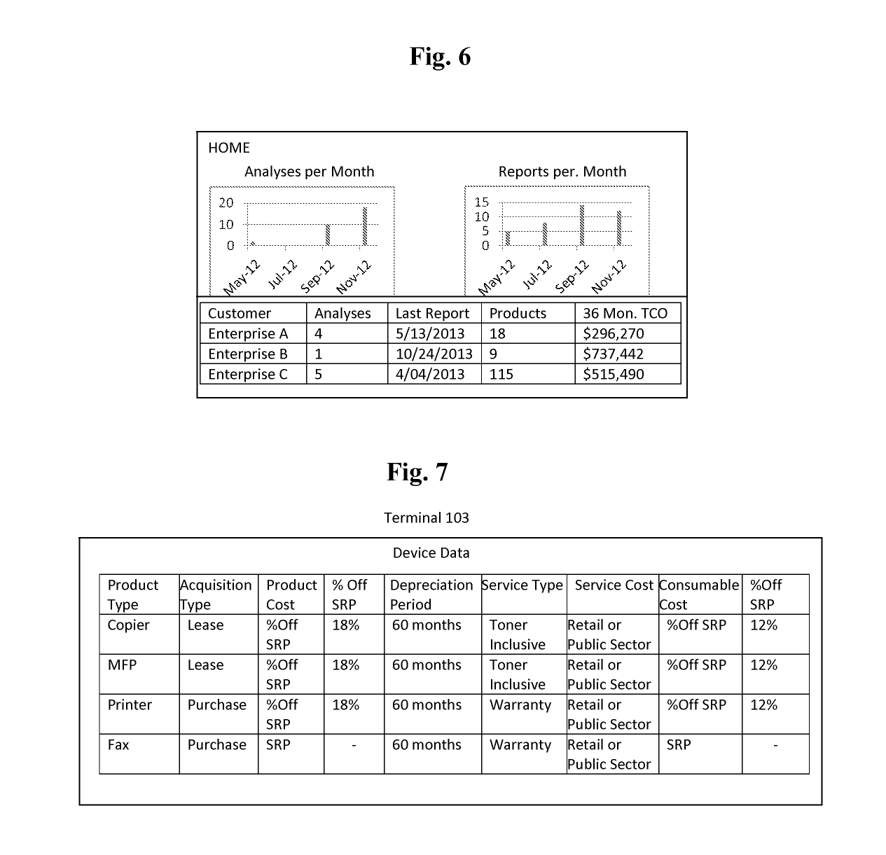

The user interface 101C is provided to facilitate access by the user to the information and the many functionalities that can be provided by the application, as shown by way of examples in FIGS. 6-12. Thus, the user may change the parameters of each device type. In addition, the user interface 101C may display additional information such as the average price.

The analysis module 101B is configured to perform enterprise analysis and/or site analysis, as needed. As discussed in more detail below, the sales and marketing support application allows the user to define and specify device parameters and such user-specified parameters are registered by the sales and marketing support application in the system. The analysis module 101B retrieves the information regarding the parameters and formats them, as necessary, into graphs, tables, etc. in order to visually show the expenditures of an enterprise. The parameters of these graphs may be changed at any point and, in addition, may be further broken down in order to analyze specific aspects of expenditures including, but not limited to, office and device.

For example, when average price is selected as product cost at the site level, the analysis module applies the average price as product cost of a device proposed to be added. On the other hand, when average price is selected as product cost at the enterprise level, the analysis module may apply the average price by default as product cost in an enterprise analysis.

The terminal apparatus 100A may be configured by an application, or some other software component (such as part of the operating system or a device driver), on a terminal device. Such terminal preferably is configured to communicate through a data network to obtain content and data from an external source. However, it should be appreciated that the inventive aspects described herein can be employed even if the device is not configured to connect to such data network, and/or is not connected to the data network.

FIG. 1B shows a system 100B which includes a multi-function peripheral (MFP) 104A, a printer 104B and a scanner 104C, all of which are interconnected by a network 102A (collectively “Network A”); an MFP 105A, a printer 105B and a terminal 105C connected to a scanner 105C-1, all of which are interconnected by a network 102B (collectively “Network B”); an enterprise manager apparatus 106 (including enterprise device database 109 connected thereto) and a terminal 103, which is connected to a network 102 which is connected to the networks 102A and 102B.

The example of FIG. 1C includes a system 100C which includes an MFP 104A, a printer 104B and a scanner 104C, all of which are interconnected by a network 102A (collectively “Network A”); an MFP 105A, a printer 105B and a terminal 105C connected to a scanner 105C-1, all of which are interconnected by a network 102B (collectively “Network B”); an enterprise manager apparatus 106, a third party server 107 and a terminal 103, which is connected to a network 102. The network 102 is connected to the intranets 102A and 102B.

As an example, each of the Networks A and B respectively connected by the intranets 102A and 102B may represent a regional office of a global/national enterprise having multiple regional offices.

FIG. 1D shows schematically another example, in which each of application server 104 and terminal 103 is connected to the network 102, in system 100D. The application server 104 provides the sales and marketing support application, on demand, to the terminal 103. In this example, the application is provided largely as a thin client, i.e. a user interface, such as via a browser, for the user to communicate interactively with the application server 104 which performs the device parameter processing and registration.

It should be appreciated that the network environment, in FIG. 1B, FIG. 1C and FIG. 1D can have an arbitrary number of devices (of various type).

The network 102 can be any data network, a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 102. In addition, the network 102 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

The MFP 104A, 105A, the printer 104B, 105B, the scanner 104C, 105C-1 can be any device having a primary functionality of printing copying, scanning, fax, etc. without providing additional functionalities.

The enterprise manager apparatus can be any of the various device management tools (such as application software, etc.) that are available to IT administrators to assist the administrators to track, monitor and otherwise manage IT (information technology) devices connected to a network. Such device management tools retrieve device settings or other device information from the devices, or other device data sources, through a network, and register such device information and allow the IT administrators to manage the devices. Thus, in the example of FIG. 1B and FIG. 1C, the terminal 103 can obtain device information for devices MFP 104A, 105A, the printer 104B, 105B, the scanner 104C, 105C-1 from the enterprise manager apparatus 106 through the network 102, and retrieve device information from the devices that belong to Network A and Network B.

Third Party Server 107 can be configured to communicate with terminal 103, through the network 102, to provide an up-to-date register of device pricing and specification for office devices, such as the devices MFP 104A, 105A, the printer 104B, 105B, the scanner 104C, 105C-1 show in FIG. 1B and FIG. 1C.

Application server 108 can be configured to communicate with terminal 103, through the network 102, to provide an application (such as the sales and marketing support application) to the terminal 103 (or another device connected to the network 102), on demand.

The application server 108 can be configured as shown by way of example in FIG. 2B. Operations and configurations of application servers are well-known in the art and therefore, in the interest of brevity (and so as not to obscure the inventive aspects described herein), are not discussed at length herein.

An example of a configuration of a user terminal (e.g., the terminal 103) is shown schematically in FIG. 2A. In the example of FIG. 2A, terminal device 200 includes a controller (or processor) 202 that communicates with a number of other components, including storage 203, display 204, input/output (such as mouse, touchpad, stylus, microphone and/or speaker with voice/speech interface and/or recognition software, etc.) 205 and a network interface 206, by way of an internal bus 201.

The storage 203 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 206 provides a connection (for example, by way of an Ethernet connection or other network connection which supports any desired network protocol such as, but not limited to TCP/IP, IPX, IPX/SPX, or NetBEUI) to a network (e.g., network 102) to enable the terminal device to communicate with another device through the network.

FIG. 2B shows an exemplary constitution of a computer 400 which can be configured by appropriate programming to operate as the enterprise manager apparatus 106 (FIG. 1B, 1C), as the third party server 107 (FIG. 1C) or as the application server 104 (FIG. 1D). The computer 400 shown in FIG. 2B includes a processor 402, and various elements connected to the processor 402 by an internal bus 401, such as a network interface 408, memory 403 and display 404. The processor 402 processes incoming requests transmitted through the network interface 408. The network interface 403 enables the application server 400 to communicate with other network-connected devices such as a terminal (e.g., the terminal 103 of FIG. 1B, FIG. 1C or FIG. 1D) and receive data or service requests.

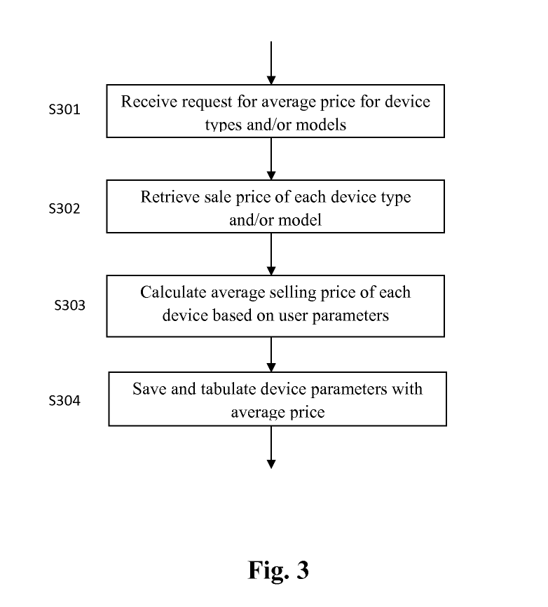

Each of the terminal 103, enterprise manager apparatus 106 and third party server 107 is configured to communicate with each other through the network 102. Through the network, the terminal 103 requests enterprise device information from the enterprise manager apparatus, as shown in FIG. 3. When the terminal initiates an enterprise analysis and defines the enterprise and device parameters, it may need information regarding the devices within an enterprise from the enterprise manager apparatus 106.

Information retrieved from the third party server 107 may include, but not limited to, pricing, hardware costs, service costs, consumable costs, other costs, usage costs, hardware and supplies pricing, printer yields, and service pricing. Pricing may refer to pricing of devices based on different parameters, including, retail costs, manufacturer suggested retail price and/or rebates. Hardware costs depend on monthly maintenance of hardware analysis based on a specific amount of time. Service costs refer to costs that are included in warrantee service and time period, extended warrantee service and may also include toner inclusive service in the case of printing products. Consumable costs calculate price of consumables based on the yield of a device. Other costs refer to costs relating to inefficiencies of a product (i.e. finishing, duplex, etc.). Usage costs calculate costs by proportionately increasing/decreasing volume of use over all devices, wherein the time frame may be adjusted to calculate cost. Hardware and supplies pricing collects printer hardware and street pricing from main internet vendors. Printer yields collects consumable yield information direct from each manufacturer at time of device introduction. Service pricing is represented as a manufacturer-branded extended warranty pack in increments of 1 to 5 years.

Additional information supplied by the third party server 107 may include energy impact, typical electricity consumption (TEC), CO2 emission, paper impact and CO2 offset. Energy impact calculates the energy consumption of devices based on data published the Environmental Protection Agency. TEC value is derived from measuring each model's electricity consumption in a lab that is setup to represent the “average office” environment and thus does not reflect actual electricity consumption, however, provides a valuable and consistent method of measuring equipment energy consumption performance. CO2 emission is calculated from the TEC of the device based on average carbon emissions for electricity generation. Paper impact refers to the production and distribution of paper that in turn produces carbon emission. CO2 offset refers to the amount of trees that can absorb carbon emissions from electricity and paper consumption.

Additionally, the terminal 103 may wish to receive up-to-date information regarding the enterprise devices to provide accurate enterprise analysis. That is, if the information stored within the terminal 103 is outdated, then the terminal 103 may refresh this data. Also, many printing devices described previously in FIG. 2B offer progress reports on their status and condition. That is, the printer may send a report describing its degradation, if any, status, malfunctions, efficiency etc. The terminal 103 requests the real-time device information from the enterprise manager apparatus 106 to provide an additional parameter to generate an enterprise analysis report.

Up-to-date information received from the enterprise manager apparatus 106 may supplement and/or substitute the information retrieved from the third party server 107. For example, the third party server 107 may not contain necessary information regarding the devices being analyzed for an enterprise analysis. Therefore, the sales and marketing support application 101 may send a price table template to the enterprise manager apparatus 106. The enterprise manager apparatus 106 then fill outs the information in the template. This information may include, but not limited to, price, maintenance, costs, etc. of the device models being used in that enterprise. This information is then stored in a database on a server, such as the one depicted in FIG. 1D, and may be accessed by any user to update information regarding certain device models for cost analysis.

These price tables may be prepared by different enterprises within different regions and countries, using different currencies. This information may then be accessed by any user utilizing the sales and marketing support application 101, regardless of default region or currency of the user.

FIG. 3 shows the process by which the sales and marketing support application 101 processes and outputs a request for calculating an average price of a product and/or products. The sales and marketing support application 101 receives a request for an average price associated with product types and/or models (S301). Product types may refer to apparatus which can perform certain function, i.e. scanner, fax, multi-function peripheral, printer, etc., as shown in FIG. 7. In an exemplary embodiment of this disclosure, the sales and marketing support application allows a user to choose to a specific device model to perform product analysis. Further, the sales and marketing support application allows the user to specify, in addition to device model and/or type, other parameters on which to perform an analysis. For example, a user may wish to filter only those device types that were purchased with a three-year warrantee. In such instance, the sales and marketing support application 101 would retrieve the prices corresponding to the device model that were purchased with a three-year warrantee. The parameters may also include, but are not limited to, accessories, service type, acquisition type, consumable costs, etc.

The sales and marketing support application 101 retrieves the sale price for the given device type and/or models, S302, associated with the parameters set by the user. The sale price information may be retrieved from the third party server 107 and/or from the enterprise manager apparatus 106. The sale price refers to the negotiated price in which the model and/or device was sold by the vendor. Vendors typically would give a higher sale price to a consumer based on the additional cost parameters.

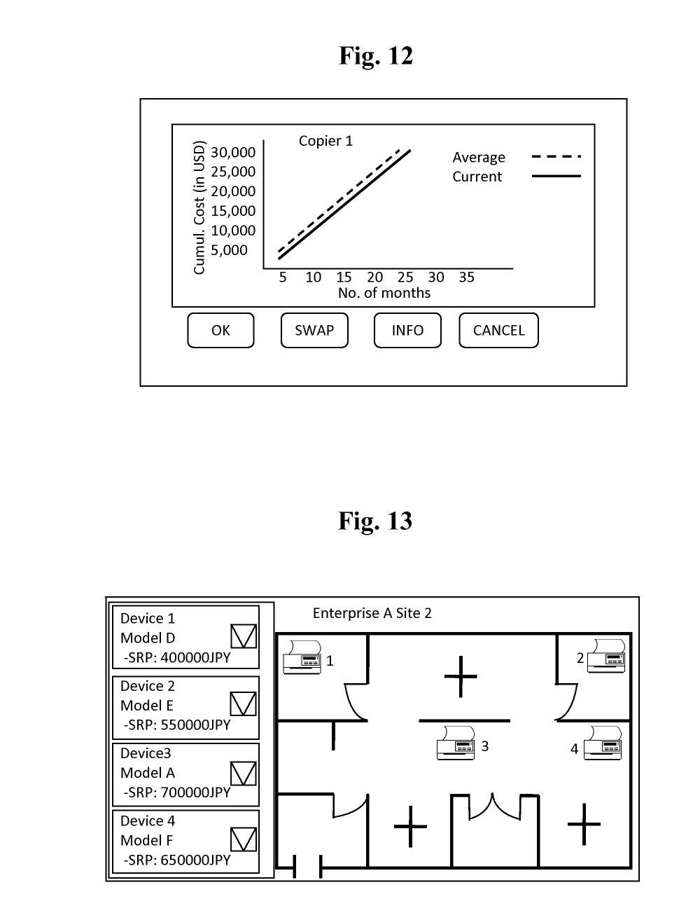

The sales and marketing support application 101 then, in S303, calculates an average price of the device type and/or model. The sales and marketing support application 101 averages the sale price of every model and/or type. For example, if a user were to request the average price for a MFP, the sales and marketing support application 101 receives the price of each device, that is consider a MFP, sold and averages them. The new calculated price is then called the average price. Initially, the analysis is performed based on the parameters entered for the enterprise. As a user specifies additional parameters, the average price may change. For example, if a user chooses to calculate the average price of MFP that were sold with a certain accessory, i.e. a maintenance cartridge, then the sales and marketing support application 101 would only retrieve the sales price of MFP sold with the given accessory. The sales and marketing support application allows the user to specify, in addition to accessories, the region in which the device was sold. For example, the sales and marketing support application allows the user to choose, as one of the parameters of the device analysis, MFPs sold in a region, preset or specified by the user, as described in FIG. 12 below.

In S304, the device parameter user interface 101C displays the data onto the terminal 103 along with user selectable options for product cost, as shown in the embodiments below. Additionally, the sales and marketing support application 101 may register the data with the third party server 107 if the data was retrieved directly from the enterprise management apparatus 106. By doing so, the third party server 107 may enlarge its database with more up-to-date information regarding the cost of products. This up-to-date information may include, but not limited to, SRP, street price and average price related to a specific country or region.

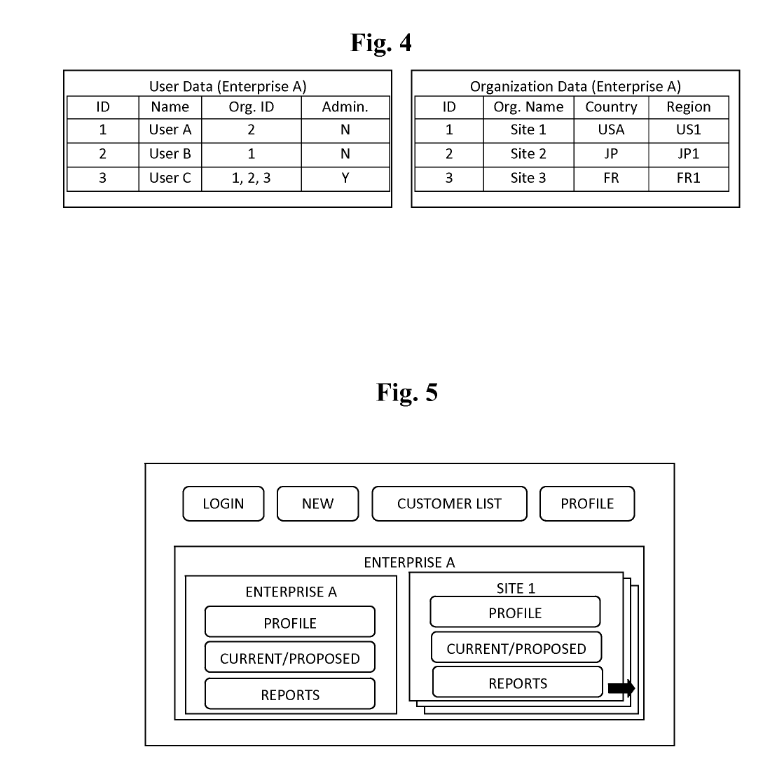

FIG. 4 shows data tables including information regarding user data and organization data. The user data represents the type of access each user, within a certain enterprise, is given. For example, User A, shown in FIG. 4, has access to organization ID number 2, while User C has access to organization ID number 1, 2 and 3. It is preferable to give certain users certain types of access for the sake of security of an enterprise. In addition to each user being associated with specific sites, each user may be associated with the specific regions of the respective sites. That is, when a user logs in and is given access to the information of an enterprise or site, the expenditure and price analysis is performed with data collected with respect to the user/enterprise's associated region.

In addition to access to specific organizations, the sales and marketing support application may limit the user to specific device tables and prices associated with the region the user is in. For example, a user in Europe may be limited to the device price tables, to the devices and prices available in that region. On the other hand, depending on the access and privileges of the specific user, the sales and marketing support application may allow the user to access device price tables associated with other regions.

In the user table shown in FIG. 4, administration status of each user is specified. By being an administrator, a user has control over adding/deleting users and controlling the privileges of each user. That is, the administrator has control over the preferences and access of each user. For example, the administrator may choose to limit or extend the site information that a specific user has access to. The organization data table is an example of information regarding sites within an enterprise. In the example shown in FIG. 4, the organization data includes information regarding the sites (Site 1, Site 2, Site 3) associated with Enterprise A. The organization data table shown in FIG. 4 also includes data indicating the country in which the site is located and the region associated with the site. Each site can be labeled by region, and site analysis may be based on parameters set for the region. Thus, when a user performs a device price analysis for a given model and/or type, the enterprise parameters may be changed to parameters specific to the site, i.e. the region of the site. At any point, the sales and marketing support application may allow the user to change the default parameters of device analysis to calculate a new average price based on these parameters

An example of a user interface screen which can be provided by the sales and marketing support application shown in FIG. 1A and/or on a terminal in the system shown in FIG. 1B, FIG. 1C or FIG. 1D is shown in FIG. 5. Once a user submits their login information, the sales and marketing support application allows the user to access the user's specific profile which contains all the preferences associated with that profile. For example, the user interface may be changed into a different language based on the preferences of the user. In addition, the sales and marketing support application allows the user to obtain reports of the respective sites and enterprises to which the user is associated. With such access, the user can obtain previous analyses.

Through this UI, the sales and marketing support application allows the user to navigate through the available options of enterprise analysis, customize the parameters of the enterprise analysis, call previous analysis reports and create new enterprise analysis reports. These custom parameters may be made a default for the enterprise and device analysis. Each user may define their own default parameters based on their own needs for expenditure analysis.

As shown in the exemplary embodiment, enterprise A has options in which a user may generate reports, look at detailed analysis of the enterprise and propose new device layout of the enterprise and generate these reports into file types such as, but not limited to, Excel sheets, PDFs and Word documents, as discussed infra. A detailed analysis of an enterprise may include, but is not limited to, the device fleet of the enterprise, the cost of office supplies (e.g. paper, stationary, etc.), utility costs and CO2 emission cost. A device fleet analysis may include a list of all printing devices (e.g. printers, scanners, fax machines, MFP) listed with the cost of each device. In order to calculate the cost of each device, the sales and marketing support application 101 may take into account the overall cost of the machine (e.g. SRP or street price), electricity cost in kWh, TCPP, CO2 emission cost and maintenance cost. The cost analysis is not limited to these parameters and may be customized by the user. For example, the sales and marketing support application may allow the user to choose a time period in which this cost analysis is made and calculated. With this option, the user can analyze the performance of devices in an enterprise for a specific time frame. Also, the sales and marketing support application allows the user to obtain a projection of future cost based on past trends. A cost report based on the given parameters may be generated by the sales and marketing support application 101. The costs reports may be saved and later recalled.

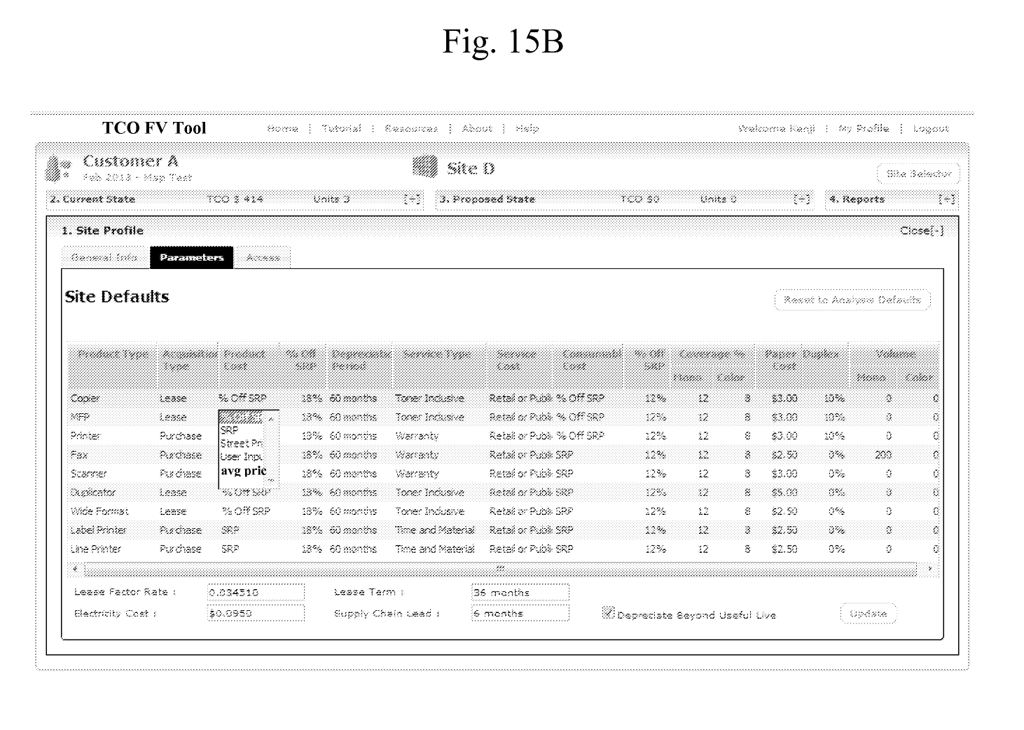

In addition to generating a detailed analysis of the enterprise, the user interface provides options through which the user may focus on individual sites within the enterprise. In this exemplary embodiment, enterprise A is made up of three sites, which previous or current analysis reports may be accessed through the user interface. The sales and marketing support application may also generate reports for the expenditures and cost of each individual site in order to further analyze the expenditures of the enterprise as a whole. The sales and marketing support application may allow the user to locate devices by referring to a floor plan of a site, as shown in FIG. 15.

FIG. 6 is an exemplary embodiment of a user interface screen (e.g., a home page) of the sales and marketing support application 101. This UI shows the frequency and regularity at which analyses has been performed and reports have been generated. Information on the home page may include, but not limited to, graphs showing the amount of analyses and reports per month as shown in the figure. In addition, the UI may include a list of the customers associated with the specific user, the amount of analyses performed for each particular enterprise and other information that may contain the amount of products an enterprise has and/or a total cost of operation for a specific time period of the enterprise. This chart may be customized to include other information based on the user's preferences. The customer names display in the 1st column may also function as a link to go into the analysis list for the customer. In the Analysis list the user can see previous analyses in more detail.

FIG. 7 is an exemplary embodiment of the user-set preferences for performing price analysis for given device types. The sales and marketing support application allows the user to specify, for each device type, parameters for a price analysis. In the embodiment, the sales and marketing support application allows the user to choose, for the given device type, acquisition type product cost, % off SRP, depreciation period, service type, service cost, consumable cost, etc.

The entries for acquisition type, service type, etc. may be chosen from a drop down menu. For example, the entries for acquisition type may include options for full purchase (i.e. paying the price for the product in full), or lease, or a payment plan negotiated for the consumer. In addition, the entries requiring a numerical value can be customized based on the user preference. For example, the entry for % Off SRP may have values ranging from 0-100. A sale person may choose to provide products and/or consumables for the given device type at percent of the standard retail price. By doing so, a sales person may further negotiate the price for the given device type based on additional features including perks and discounts for the upkeep cost of the given device type.

Additionally, the sales and market support application 101 may calculate the average price and the percentage that the average price is off the SRP based on the user set parameters. For example, if the average price is calculated to be $500 for 10,000 units and the SRP is $1,000, then the % off SRP may be 50% based on the standard deviation of the street prices retrieved from the third party server.

Further, when the sales and marketing support application 101 performs an average price analysis, the parameters may be taken from the given chart. That is, when retrieving the sale price of each device, S302 in FIG. 3, the sales and marketing support application 101 may only take into consideration the prices of devices sold with the given parameters set by the user. For the given embodiment, if the user were to choose to perform a price analysis, the sales and marketing support application 101 would only retrieve the prices of devices that fall into the category of a copier, sold by lease, with an 18% off product costs, etc. The prices are retrieved either from a third party server or by internal storage of the terminal 103. Each price is then averaged and displayed on the terminal 103, as discussed infra.

FIG. 8 shows an exemplary embodiment of a price table generated by the sales and marketing support application 101. The table in the given embodiment lists the prices associated with a device type by region (or country). As shown in FIG. 8, the sales and marketing support application 101 may retrieve products associated with multiple companies. Also, based on the parameters specified by the user, the sales and marketing support application 101 may perform a price analysis based on the products sold within a specific region. The sales and marketing application 101 then tabulates the information including, but not limited to, the price information along with device type, street price (referring to the lowest selling price of the given product) and the calculated average price.

As previously described the average price may be calculated based on the parameters specified by the user. That is, the average price may be calculated based on the selling prices of a given product within a certain region. For example, the user may choose to specify a region where products have been sold in order to perform the calculation of an average price. In addition, a user may choose to omit the manufacturer as a parameter for the price analysis in the given embodiment. That is, a user may choose to have the average price calculated based solely on device type. The sales and marketing support application 101 may provide a new calculation, giving a unique output based on the change of the user set parameters.

FIG. 9 is an exemplary embodiment showing a price table calculated and maintained for device model “Copier 1”. Such table includes, for each region, units sold, SRP, street price and average price. The regions may be specified by the user and may be any land mass including, but not limited to, continent, country, geographical area of a country or continent, state, city, etc. Each average price may also tabulated in the currency of the given region.

FIG. 10 is an exemplary embodiment of the cost analysis for an enterprise and the sites associated with said enterprise. In the given embodiment, the enterprise is listed with the sites along with the information regarding the last update of the products for a given site, the creation date of the site analysis and current state and output of the products within each site.

When performing an enterprise analysis, the sales and marketing support application 101 registers every device employed at the enterprise. Based on the parameters set for the enterprise, the sales and marketing support application 101 then populates the data device parameters data for each device. These parameters may be dependent on the region of the specific site and/or enterprise. That is, the values for the parameters set by the user may be dependent on the specific region of the site, as described infra. Therefore, if two sites that employ the same device are located in different regions then, the values of the parameters for each device may be different. One of these parameters may include the average price of the device. When adding a new device for cost analysis, the sales and marketing support application 101 may calculate an average price on the enterprise level and an average price for a plurality of countries and/or regions specified by the user. Cost analysis based on the enterprise level may refer to, for example, an average price for the devices and/or models calculated based on the price that the enterprise paid for them.

The information generated by sales and marketing support application 101 is then saved on the storage of the terminal and can be called by the user. At any point, the user may input or update the information tabulated by the sales and marketing support application 101. That is, if the user inputs a new device or value for a parameter then, the sales and marketing support application 101 calculates and registers a new average price.

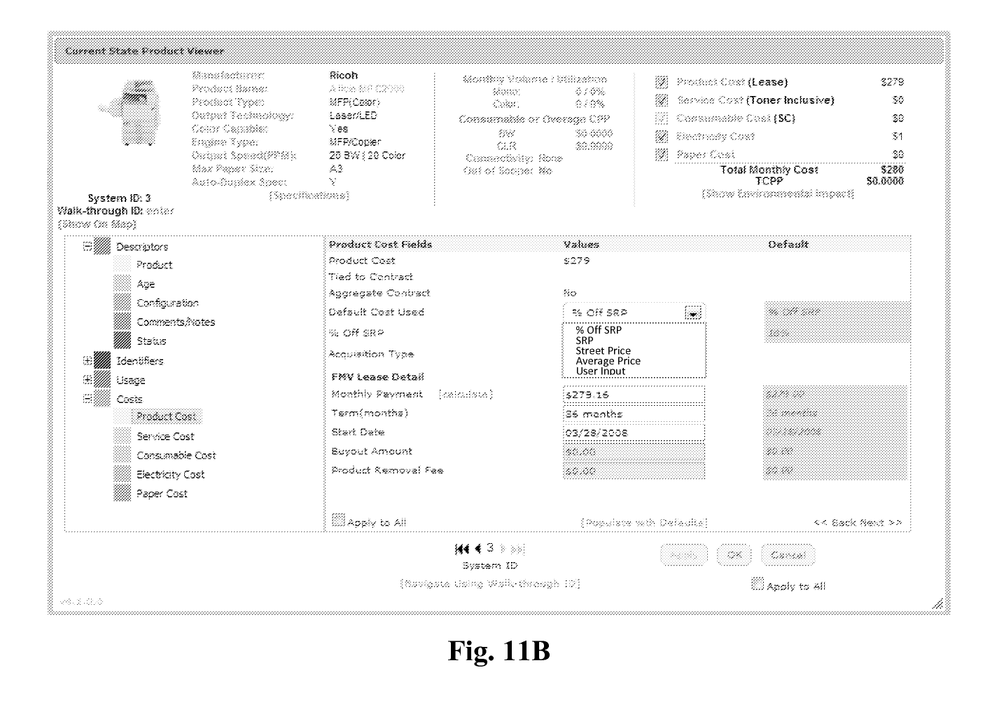

An example of a user interface screen through which the sales and marketing support application allows the user to change the parameters for a cost analysis of a product and/or add a new product or device for enterprise analysis is shown in FIG. 11A. For example, the user may first add a device and/or model, before proceeding to an enterprise cost analysis. After choosing the device, the user may choose the parameters for cost analysis. These parameters may be automatically populated based on previous or default enterprise/site parameters. Additionally, the sales and marketing support application allows the user to specify or edit the values for each given parameter, such as shown in FIG. 11B. The sales and marketing support application 101 may then calculate a new cost analysis, including average price, based on this data.

In the given embodiment, the user may choose a time period in which to perform a cost analysis of a product, i.e. months. Parameters such as electricity, paper, service, etc. are dependent on the time period, therefore the sales and marketing support application 101 populates the device parameter data based on the time parameters. Whenever the user changes one of the current parameters for price analysis, the sales and marketing support application 101 calculates new values for the remaining fields of the cost analysis, i.e. SRP, sales price and average price. In addition, the sales and marketing support application 101 may calculate an average price based on the given time parameter. The average price may be dependent on the region specified by the user.

FIG. 12 is an exemplary embodiment of a graph created by the sales and marketing support application 101 based on time parameters. The graph shows the cumulative costs of a device vs. the current lifetime of the device. Additionally, the graph shows the average cost for similar devices. The average price maybe calculated using the enterprise parameters set by the user or site parameters. The site parameters may include region specific parameters assigned by the user. That is, the user may specify that the average price is to be calculated based on a specified region and such region may be one or a plurality of countries or regions, or a region defined by the user. Additionally, the graph of the current embodiment may analyze the cumulative costs of a device type and compare it to a specific model based on the parameters set by the user.

The sales and marketing support application 101 may also create reports corresponding to any of the parameters set by the user into file types such as, but not limited to, Excel sheets, PDFS, Word Documents, etc. That is, the sales and marketing support application 101 may generate graphs based on the retrieved parameter data and calculated average price for a given enterprise, device and/or model type.

Another exemplary embodiment of a UI used to propose new device layouts for an enterprise or site is shown in FIG. 13. In this exemplary embodiment, the UI includes a floor plan of the site in which a user may reorganize or introduce new machines to an office layout. The sales and marketing support application 101 may then calculate and display an average price of the device type and/or model. The prices listed for each device is based on the enterprise parameters set by the user.

This type of analysis allows the user to create maps easily for customer sites. This analysis may integrate all the types of analysis, as discussed previously, including but not limited to, SRP, street price, maintenance costs, idle costs, stationary costs, etc.

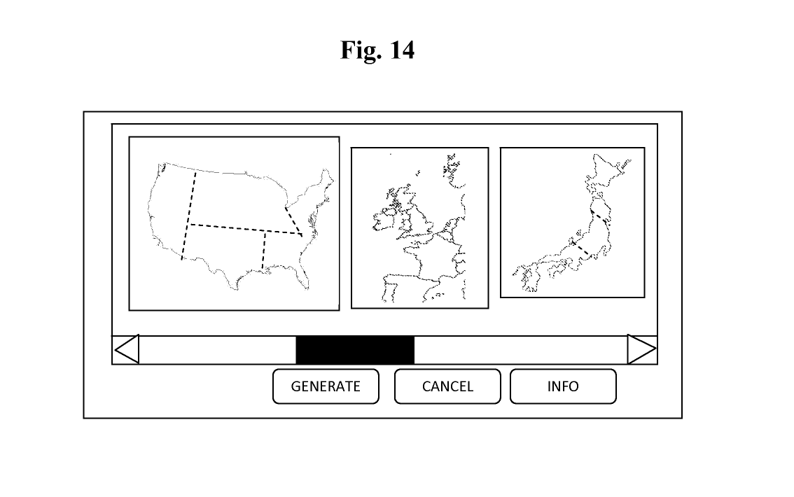

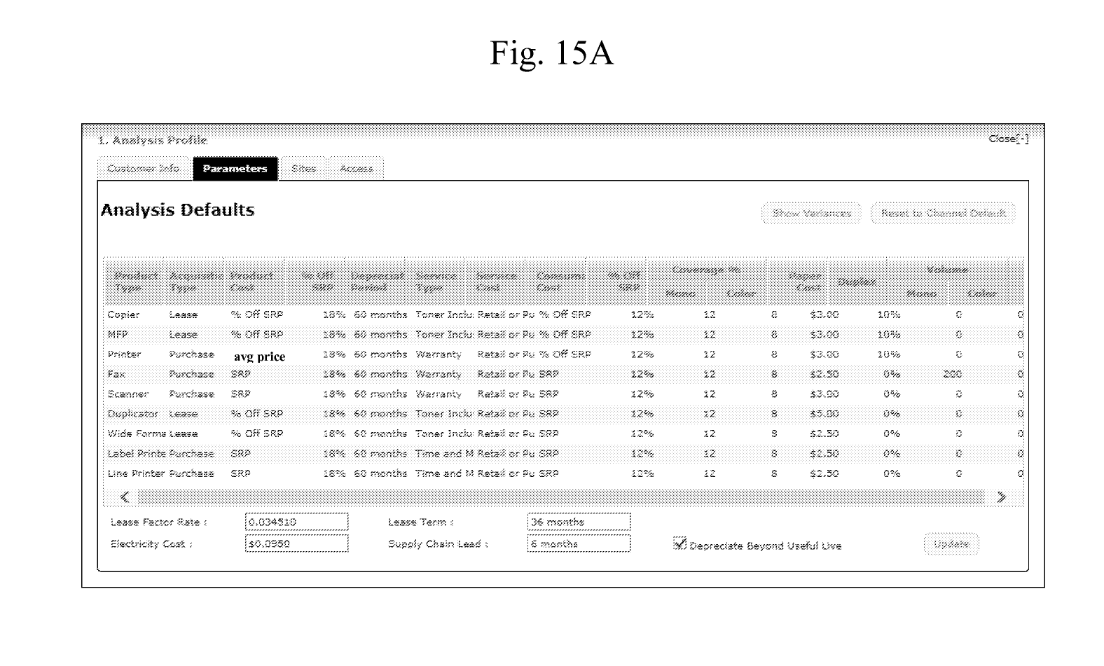

FIG. 14 is an exemplary embodiment of a user interface wherein the user may define the region in which to perform enterprise analysis for a given device and/or model. The user may define the region based on one or more countries and/or areas of one or more countries. The sales and marketing support application 101 then collects all the data for a chosen model and/or device from the defined region and then calculates the average price based on the parameters chosen.

For example, a user may specify the west coast of the United States as the region the user wishes a cost analysis to be performed. The sales and marketing support application 101 then collects prices and costs for the device type or model which the user had chosen. In addition, the sales and marketing support application 101 then filters the prices of models and/or devices that correspond to the parameters set by the user within the given region. The sales and marketing support application 101 then populates the parameters list with values, calculating an average price using the sale price of every specific device and averaging the sales prices. Additionally, the user may choose to perform cost analysis based on the products sold within the entire country. Therefore, the average price generated would take into account every product sold, the price each product was sold for and calculate the average price per unit within a specific country.

Additionally, if the user selects to perform an enterprise analysis, the sales and marketing support application 101 may automatically select the regions in which the enterprise is located and perform cost analysis on preset parameters. Similarly, the user may choose the sales and marketing supports application 101 to perform cost analysis based solely on the products employed within each site. Thereby, when an additional product and/or device is added to the enterprise, the sales and marketing support application 101 calculates a new average price.

Another example in which an enterprise has facilities at plural sites disposed over plural regions or countries will now be discussed. The tools described herein can be particularly useful in the circumstance that available device models and their configurations, options and prices are different in various regions, countries and/or sales companies (e.g., an equipment manufacturer may be associated with many marketing arms, such as subsidiaries, divisions, related companies, distributors, etc.). Further, even if a device model is commonly available in different regions, countries and/or sales companies, the price and configuration maybe different. In such example, a tool (referenced herein as “TCO FV”) may be configured to include the features described herein to perform an analysis for such an enterprise (e.g., user's customer or employer) which has many branches or sites distributed over a wide expanse geographically, such that acquisition price or cost, for the same device model, may vary. The TC FV tool can be provided as a sales and marketing support application, and/or provided to a user within an enterprise to assist in managing information technology costs, expenditures, etc.

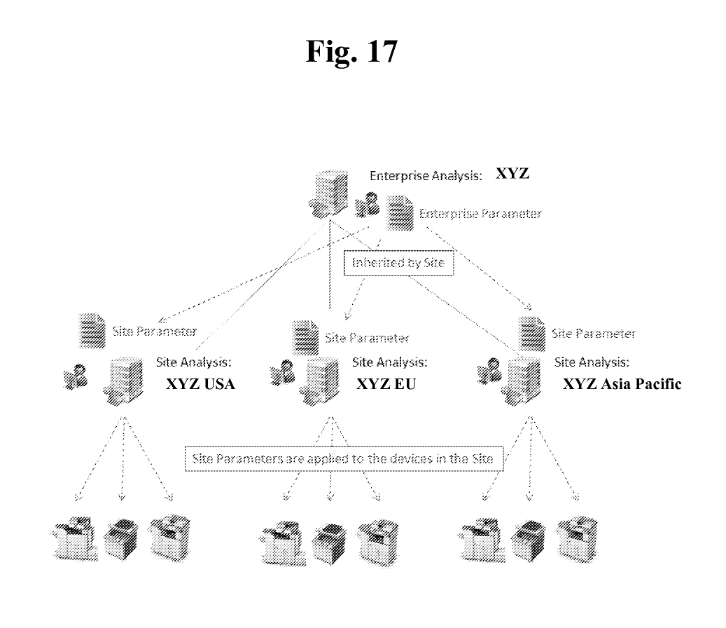

Conventional systems for performing enterprise and/or site analyses (e.g., total cost of ownership) typically require the user to manually enter many, if not all, of the device parameters when registering a device. On the other hand, the TCO FV tool (including a device parameter module, such as 101A in FIGS. 1A-1C) employs an approach in which default parameters can be set at an enterprise level, and device parameters at the site level can inherit default values set at the enterprise level, as shown by example in FIG. 17. Further, the default values at the site level can be applied to devices registered in association with the site. For example, when a particular device is added as an instance of the corresponding device model, the user-selectable options of the particular device are automatically populated based on the device parameters of the device model registered at the site (or enterprise) level.

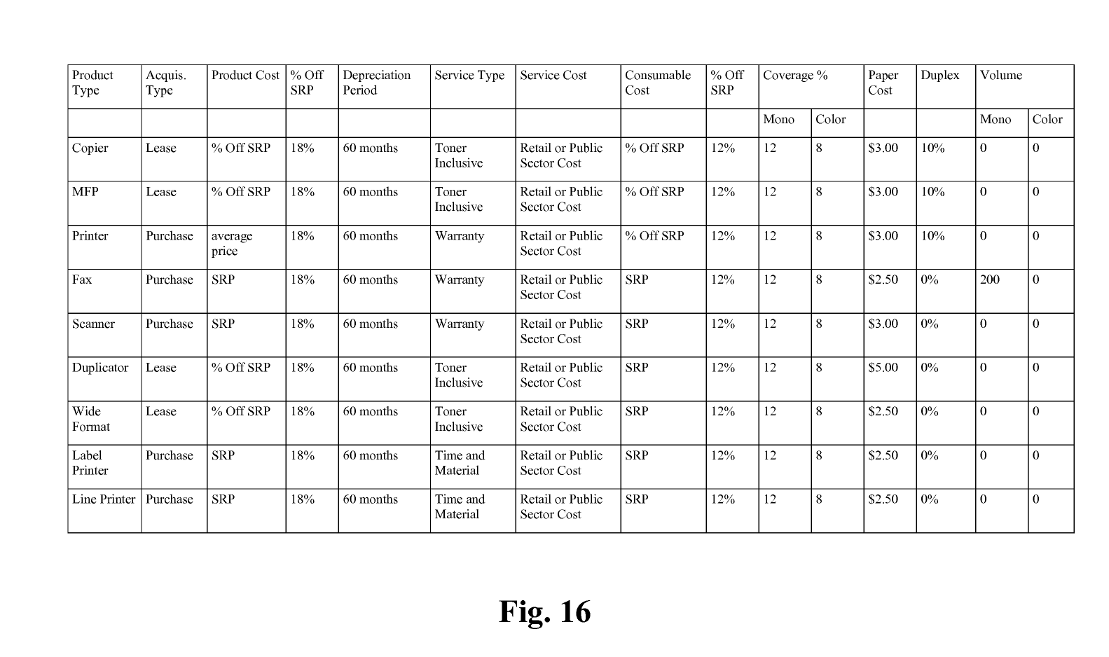

Examples of such user interface display screens for setting default parameters or values are shown in FIG. 15A (enterprise level) and FIG. 15B (site level). In the examples shown in FIGS. 15A and 15B, the user can set various parameters, such as, for example, acquisition type, product cost, % Off SRP (for product cost), depreciation period, service type, service cost, consumable cost, % Off SRP (for consumable cost), toner coverage, paper cost, duplex, total volume, etc., which are summarized below. FIG. 16 shows an example of default values set for the following device types: copier; MFP; printer; fax; scanner; duplicator; wide format; label printer; line printer.

| Parameter | Description | |
|---|---|---|
| Acquisition | how customer acquire products | Candidate: |
| Type | | Purchase |
| | | Lease |
| | | Rental |
| Product Cost | Cost of products | Candidate: |
| | | % Off SRP* |
| | | SRP |
| | | Street Price |
| | | User Input |
| | | Average Price* |
| | | *System calculates and stores average |
| | | prices for each product, currency. |
| % Off SRP | Percentage to reduce the price | Range: 0%-100% |
| (product) | from SRP of Products | |
| Depreciation | Depreciation Period for products | Unit: months |
| Period | | |
| Service Type | | Candidate: |
| | | Warranty |
| | | Toner Inclusive |
| | | MDS/MPS |
| | | Non Inclusive |
| | | Time and Materials |
| Service Cost | Cost of service | Candidate: |
| | | User Input |
| | | Retail or Public Sector |
| | | Cost |
| Consumable | Cost of consumables | Candidate: |
| Cost | | % Off SRP |
| | | Retail or Public Sector |
| | | Cost |
| | | SRP |
| % Off SRP | Percentage to reduce the price | Range: 0%-100% |
| (consumable) | from SRP of consumables. | |
| Coverage % | Coverage of mono operation | Range: 0%-100% |
| | Coverage of color operation | Range: 0%-100% |
| Paper Cost | Cost per 500 sheets of paper. | |
| Duplex | Percentage of duplex print | |
| Volume | Total volume of mono operation | |
| | Total volume of color operation | |

Other parameters that can be set for every device include lease factor rate, electricity cost, lease term, supply chain lead, depreciate beyond useful live, volume split for mono/color, etc.

| Additional | | |
|---|---|---|
| Parameters | | Description |
| Lease Factor Rate | | Additional Rate for Lease |
| Electricity Cost | | Cost per kWh |
| Lease Term | | Duration to lease products |
| Supply Chain Lead | | Total duration of Supply Chain |
| Depreciate Beyond | | Enable/Disable to calculate depreciate cost beyond |
| Useful Live | | the useful live (Depreciation Period) |
| Volume | Mono | Percentage of Mono Volume against Total Volume |
| Split | Color | Percentage of Color Volume against Total Volume |

The parameters set here are applied to devices when they are registered to the system, and the user is permitted to change the values for each device on the system whenever the user wants.

The TCO FV tool allows the user to generate an enterprise analysis (per customer) and site analysis (per site). For example, for an enterprise XYZ that has divisions XYZ USA, XYZ Europe and XYZ Asia Pacific, an enterprise analysis of XYZ may include site analyses for XYZ USA, XYZ Europe and XYZ Asia Pacific.

As shown in FIG. 17, in a typical workflow for such example, the user can set parameters for an enterprise analysis “XYZ”. The parameters set for enterprise XYZ are inherited by site analyses “XYZ USA”, “XYZ EU”, “XYZ Asia Pacific”. On the other hand, the user can modify the parameters in each site analysis, as needed. Devices registered to “XYZ USA” site would inherit the parameters set in “XYZ USA” site analysis (likewise for “Ricoh EU” and “Ricoh Asia Pacific”, and the user can modify the inherited parameters, as needed. Thus, the user can set parameters for all of the devices and set parameters for each site, quickly. Such user features can be helpful, since values of the parameters can vary across countries, regions, deals, etc.

Product cost is one of the parameters that can be set for each device type and it (i.e. product cost) can have these candidates: % Off SRP (Suggested Retail Price); SRP; Street Price; User Input; Average Price.

SRP and Street Price for each device model can be registered in the system in advance and/or may be updated periodically (by push or pull). As discussed herein, in some case, a user would prefer not to use SRP or Street Price and would like to use an average price (i.e. average of sales prices for units of a device model actually sold in the particular country or region). The system can be configured to update the average price data each time sales price data is updated.

The following device master table (Table 1) and price data table (Table 2) show one example.

TABLE 1

| ID | Model | Manufacturer |
|---|---|---|
| 1 | MPC 2500 | XYZ |
| 2 | MPC 3000 | XYZ |
| 3 | MPC 3500 | XYZ |

TABLE 2

| ID | Device ID | Country | SRP | Street Price | Average Price |
|---|---|---|---|---|---|
| 1 | 1 | US | USD 6,000 | USD 5,000 | USD 5,200 |
| 2 | 1 | JP | JPY 590,000 | JPY 490,000 | JPY 510,000 |
| 3 | 1 | FR | EUR 5,500 | EUR 4,000 | EUR 5,000 |
| 4 | 2 | US | USD 7,000 | USD 6,000 | USD 6,500 |
| 5 | 2 | JP | JPY 690,000 | JPY 590,000 | JPY 620,000 |
| 6 | 2 | FR | EUR 6,500 | EUR 5,000 | EUR 5,600 |
| 7 | 3 | US | USD 8,000 | USD 7,000 | USD 7,800 |
| 8 | 3 | JP | JPY 790,000 | JPY 690,000 | JPY 700,000 |
| 9 | 3 | FR | EUR 7,500 | EUR 6,000 | EUR 6,900 |

The TCO FV tool is configured such that when a device is registered to the system or a device price is input/modified in the system, the system calculates the average price for each model and for each country immediately. On the other hand, when a device price of a registered device is input or modified, the system (device parameter module) calculates and registers, for each country or region, an average price of the particular device in that country or region. When the user selects “average price” for the product cost field in parameter settings, the average price is applied to a device when the device is registered to the system.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

The orders in which the steps are performed in the aforementioned methods are not limited to those shown in the examples of FIG. 3 and may be switched as long as similar results are achieved. Also, it should be noted that the methods illustrated in the examples of FIG. 3 may be implemented using any of the embodiments shown in FIGS. 1A-1D.

Further, the terms “device” and “devices” are used broadly (unless otherwise explicitly qualified) herein to encompass not only equipment, but any information technology provisions (product or service) that can be purchased, leased, etc., and thus has an associated cost or price.

In addition, other features may be employed, including use of third party device data and use of real-time data of printer pricing within given regions to calculate an average price of a product. For example, the third party data may be retrieved or obtained to determine SRP (and even possibly Street Price) of a product. Further, average price may be region-specific. In addition, such average price may be displayed along with SRP and Street Price, for multiple regions.

In another aspect, the displayed cost information may include, in addition to the average price, total cost of operation (TCO), preferably corresponding to real time data of the device. Further, the average cost per unit (e.g., day to day cost of operating a device, such as, but not limited to, cost of energy, cost of maintenance, and in the case of printers, additionally, cost of ink/toner and paper).

What is claimed is:

1. A sales and marketing support application including one or more programs of instructions embodied in a non-transitory computer readable medium and executable by a computer to configure the computer to comprise:
a device parameter module that
registers for each specific site amongst one or more sites of an enterprise, a plurality of devices employed at the specific site,
sets, for each device type, enterprise parameters, including device type parameters, at enterprise level for the enterprise,
sets, for each particular site amongst the one or more sites of the enterprise, site parameters inheriting the corresponding enterprise parameters, and
automatically populates, for the plurality of devices at site level amongst the one or more sites of the enterprise, device parameters data to inherit the device type parameters that were set at enterprise level for the enterprise; and
a device parameter user interface configured for user to set and modify the device parameters data of a particular device at the site level, and to set and modify the device type parameters of each device type at the enterprise level, and
wherein the device parameter user interface provides a plurality of user-selectable options for product cost as a device parameter of a particular device, and the user-selectable options for product cost include average price of sold units of a device model corresponding to the particular device.

2. The sales and marketing support application of claim 1, wherein when the particular device is added as an instance of the corresponding device model, the user-selectable options of the particular device are automatically populated based on the device type parameters of the device model corresponding to the particular device.

3. The sales and marketing support application of claim 1, wherein the average price provided by the device parameter user interface as the product cost of the particular device reflects an average of selling price of units sold in a specified country or region of the device model corresponding to the particular device.

4. The sales and marketing support application of claim 1, wherein the user-selectable options provided by the device parameter user interface for product cost include average price, suggested retail price (SRP), street price and percent off SRP.

5. The sales and marketing support application of claim 1, wherein the device parameter module registers, for each device and for each country or region, the average price of the device in the country or region.

6. The sales and marketing support application of claim 1, wherein the device parameter module registers, for each specific site and as the average price of the particular device, an average of selling price of units that were sold in a country or region of the site, of the device model corresponding to the particular device.

7. The sales and marketing support application of claim 1, wherein the device parameter module registers, for each device and for each country or region, the average price, suggested retail price (SRP) and street price of the device in the country or region.

8. The sales and marketing support application of claim 1, wherein when the device parameter module registers an additional device, the device parameter module calculates and registers, for each specified country or region amongst plural countries or regions, an average price of the additional device in the specified country or region.

9. The sales and marketing support application of claim 1, wherein when a device price of the particular device is input or modified, the device parameter module calculates and registers, for each specified country or region amongst plural countries or regions, an average price of the particular device in the specified country or region.

10. The sales and marketing support application of claim 1, wherein when average price is selected as product cost at site level or enterprise level, the device parameter module, when an additional device is to be registered, applies average price as the device price of the additional device.

11. The sales and marketing support application of claim 1, further comprising:
an analysis module that retrieves the device parameters data for each device amongst plural devices of a site, performs a site analysis based on the retrieved device price data of the plural devices of the site, and outputs a site analysis report reflecting the site analysis,
wherein for an enterprise analysis, the analysis module performs, for each particular site amongst the one or more sites of the enterprise, a site analysis of the particular site, and outputs an enterprise analysis report that includes the site analysis for each particular site amongst the one or more sites of the enterprise.

12. The sales and marketing support application of claim 11, wherein when average price is selected as product cost at the site level, the site analysis performed by the analysis module applies the average price as product cost of an additional device proposed to be added.

13. The sales and marketing support application of claim 11, wherein when average price is selected as product cost at the enterprise level, the enterprise analysis performed by the analysis module applies the average price as product cost of an additional device proposed to be added.

14. A method performed by a sales and marketing support application including one or more programs of instructions embodied in a non-transitory computer readable medium and executed by a computer, the method comprising:
registering for each specific site amongst one or more sites of an enterprise, a plurality of devices employed at the specific site;
setting, for each device type, enterprise parameters, including device type parameters, at enterprise level for the enterprise, and setting, for each particular site amongst the one or more sites of the enterprise, site parameters inheriting the corresponding enterprise parameters;
populating, for the plurality of devices at site level amongst the one or more sites of the enterprise, device parameters data to inherit the device type parameters that were set at enterprise level for the enterprise;
providing a device parameter user interface for user to set and modify the device parameters data of a particular device at the site level, and to set and modify the device type parameters of each device type at the enterprise level; and
providing through the device parameter user interface a plurality of user-selectable options for product cost as a device parameter of a particular device, wherein the user-selectable options for product cost include average price of sold units of a device model corresponding to the particular device.

15. The method of claim 14, further comprising:
registering, for each device and for each country or region amongst plural countries or regions, the average price of the device in the country or region.

16. The method of claim 14, further comprising:
registering, for each device and for each country or region amongst plural countries or regions, the average price, suggested retail price (SRP) and street price of the device in the country or region.

17. The method of claim 14, further comprising:
registering an additional device for the enterprise, and calculating and registering, for each specified country or region amongst plural countries or regions, an average price of the additional device in the specified country or region.

18. The method of claim 14, further comprising:
calculating and registering, when a device price of the particular device is input or modified, for each specified country or region amongst plural countries or regions, an average price of the particular device in the specified country or region.

19. The method of claim 14, further comprising:
retrieving the device parameters data for each device amongst plural devices of a site, and performing a site analysis based on the retrieved device parameters data of the plural devices of the site; and
outputting a site analysis report reflecting the site analysis,
wherein when average price is selected as product cost at the site level, the site analysis applies the average price as product cost of an additional device proposed to be added.
